(19) United States
(12) Patent Application Publication
(10) Pub. No.: US 2025/0330996 A1
(43) Pub. Date: Oct. 23, 2025

(54) NON-CODEBOOK-BASED TRANSMISSION OF SOUNDING REFERENCE SIGNALS

(71) Applicant: Apple Inc., Cupertino, CA (US)

(72) Inventors: Yushu Zhang, Beijing (CN); Dawei Zhang, Saratoga, CA (US); Haitong Sun, Saratoga, CA (US); Hong He, San Jose, CA (US); Huaning Niu, San Jose, CA (US); Seyed Ali Akbar Fakoorian, San Diego, CA (US); Sigen Ye, San Diego, CA (US); Wei Zeng, Saratoga, CA (US); Weidong Yang, San Diego, CA (US)

(73) Assignee: Apple Inc., Cupertino, CA (US)

(21) Appl. No.: 18/860,581

(22) PCT Filed: Apr. 6, 2023
(86) PCT No.: PCT/US2023/017698

§ 371 Date: Oct. 25, 2024

Related U.S. Application Data
(60) Provisional application No. 63/336,214, filed on Apr. 28, 2022.

(51) Int. Cl. H04W 72/231; H04B 7/06; H04L 5/00; H04W 72/51; H04W 76/20

(52) U.S. Cl. CPC H04W 72/231; H04B 7/0626; H04L 5/0051; H04W 72/51; H04W 76/20

(57) ABSTRACT

The present application relates to devices and components including apparatus, systems, and methods to perform a non-codebook-based SRS transmission. In an example, eight or more SRS resources are used for the non-codebook-based SRS transmission. In this example, a base station configures the UE to use the eight or more SRS resources. Upon receiving an SRS transmission of the UE, the base station can send DCI to the UE to indicate an uplink resource allocation. This allocation can rely on precoding weights used for the eight or more SRS transmissions. The DCI can have a relatively reduced size for the resource allocation indication.

### CROSS REFERENCE TO RELATED APPLICATION

This application is a 371 U.S. National Phase of PCT International Patent Application No. PCT/US2023/017698, filed Apr. 6, 2023, entitled “NON-CODEBOOK-BASED TRANSMISSION OF SOUNDING REFERENCE SIGNALS,” which claims priority to U.S. Provisional Application No. 63/336,214, filed Apr. 28, 2022, entitled “NON-CODEBOOK-BASED TRANSMISSION OF SOUNDING REFERENCE SIGNALS”. The contents of this application are hereby incorporated by reference in their entireties for all purposes.

### BACKGROUND

Cellular communications can be defined in various standards to enable communications between a user equipment and a cellular network. For example, Fifth Generation mobile network (5G) is a wireless standard that aims to improve upon data transmission speed, reliability, availability, and more.

### BRIEF DESCRIPTION OF THE DRAWINGS

FIG. 1 illustrates an example of a network environment, in accordance with some embodiments.

FIG. 2 illustrates an example of a non-codebook-based transmission of sounding reference signals (SRSs), in accordance with some embodiments.

FIG. 3 illustrates an example of an operational flow/algorithmic structure for a user equipment (UE) using a non-codebook-based transmission of SRSs, in accordance with some embodiments.

FIG. 4 illustrates an example of an operational flow/algorithmic structure for a base station using a non-codebook-based transmission of SRSs, in accordance with some embodiments.

FIG. 5 illustrates an example of using download control information (DCI) for a non-codebook-based SRS transmission, in accordance with some embodiments.

FIG. 6 illustrates another example of using DCI for a non-codebook-based SRS transmission, in accordance with some embodiments.

FIG. 7 illustrates an example of reporting SRS resource indicator (SRI) combinations in support of a DCI transmission, in accordance with some embodiments.

FIG. 8 illustrates an example of using multiple DCIs for a non-codebook-based SRS transmission, in accordance with some embodiments.

FIG. 9 illustrates an example of receive components, in accordance with some embodiments.

FIG. 10 illustrates an example of a UE, in accordance with some embodiments.

FIG. 11 illustrates an example of a base station, in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

Generally, a user equipment (UE) can send sounding reference signals (SRSs) to a base station such that the base station can estimate an uplink channel quality and manage at least uplink communications from the UE. SRS resources are configured by the base station for the UE. The UE can use the SRS resources for a non-codebook-based SRS transmission. According to this transmission scheme, the UE does not receive information from the base station about precoding weights and, instead, generates such precoding weights based on downlink measurements (e.g., on channel state information reference signals (CSI-RSs). Based on the SRS transmission, the base station determines resource allocations for the uplink channel and indicates this allocation to the UE by sending downlink control information (DCI) thereto. The resource allocation can take the form, at least in part, of an SRS resource indicator (SRI).

In an example, eight or more SRS resources may be configured by the base station. In this example, the size of the SRI indicated in the DCI can become large (e.g., eight or more bits). Embodiments of the present disclosure involve using a DCI having a relatively reduced size (e.g., using less than eight bits for the SRI information). In one example, rather than indicating the SRI directly, the DCI indicates a number of demodulation reference signal (DMRS) ports, where this number is associated with a corresponding SRI in a predefined manner. In another example, the DCI indicates a number of DMRS ports, and this number is associated with a number of SRI combinations. In this case, the DCI can also indicate an SRI for a selection of a corresponding SRI combination. In yet another example, the UE may report possible SRI combinations for each number of DMRS ports. In this example, the DCI can indicate one of the numbers of DMRS ports and/or an SRI corresponding to one of the possible SRI combinations. In a further example, an SRI indicated in first DCI having a first format can be based on SRS resources configured for second DCI having a second format.

In the interest of clarity of explanation, SRS transmissions using eight SRS ports are described herein. However, the embodiments of the present disclosure are not limited as such and equivalently apply to a larger number of SRS ports (e.g., twelve, sixteen, etc.). Further, embodiments are described in connection with 5G networks. However, the embodiments are not limited as such and similarly apply to other types of communications networks including other types of cellular networks.

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “base station” as used herein refers to a device with radio communication capabilities, that is a network component of a communications network (or, more briefly, a network), and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “network” as used herein refers to a communications network that includes a set of network nodes configured to provide communications functions to a plurality of user equipment via one or more base stations. For instance, the network can be a public land mobile network (PLMN) that implements one or more communication technologies including, for instance, 5G communications.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “3GPP Access” refers to accesses (e.g., radio access technologies) that are specified by 3GPP standards. These accesses include, but are not limited to, GSM/GPRS, LTE, LTE-A, and/or 5G NR. In general, 3GPP access refers to various types of cellular access technologies.

The term “Non-3GPP Access” refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC), whereas untrusted non-3GPP accesses interwork with the EPC/5GC via a network entity, such as an Evolved Packet Data Gateway and/or a 5G NR gateway. In general, non-3GPP access refers to various types on non-cellular access technologies.

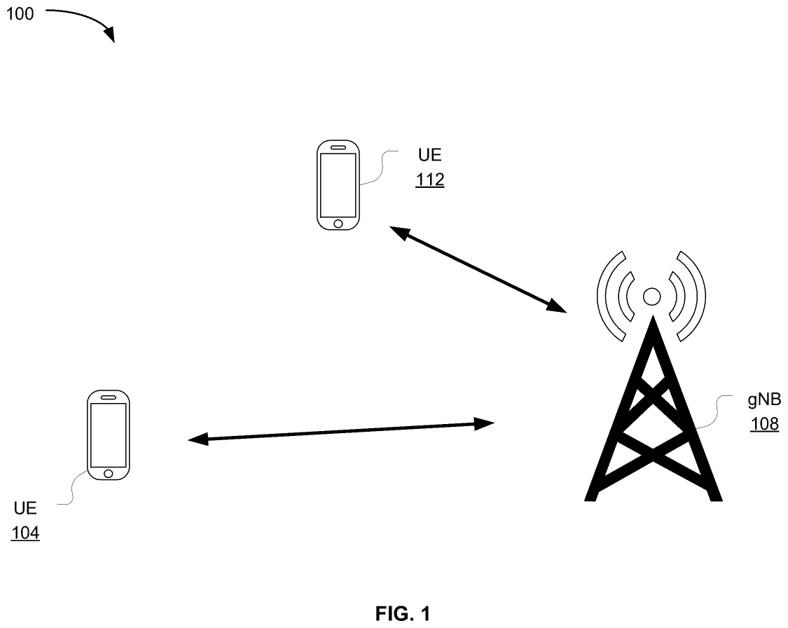

FIG. 1 illustrates a network environment 100, in accordance with some embodiments. The network environment 100 may include a UE 104 and a gNB 108. The gNB 108 may be a base station that provides a wireless access cell, for example, a Third Generation Partnership Project (3GPP) New Radio (NR) cell, through which the UE 104 may communicate with the gNB 108. The UE 104 and the gNB 108 may communicate over an air interface compatible with 3GPP technical specifications, such as those that define Fifth Generation (5G) NR system standards.

The gNB 108 may transmit information (for example, data and control signaling) in the downlink direction by mapping logical channels on the transport channels and transport channels onto physical channels. The logical channels may transfer data between a radio link control (RLC) and MAC layers; the transport channels may transfer data between the MAC and PHY layers; and the physical channels may transfer information across the air interface. The physical channels may include a physical broadcast channel (PBCH), a physical downlink control channel (PDCCH), and a physical downlink shared channel (PDSCH).

The PBCH may be used to broadcast system information that the UE 104 may use for initial access to a serving cell. The PBCH may be transmitted along with physical synchronization signals (PSS) and secondary synchronization signals (SSS) in a synchronization signal block (SSB). The SSBs may be used by the UE 104 during a cell search procedure (including cell selection and reselection) and for beam selection.

The PDSCH may be used to transfer end-user application data, signaling radio bearer (SRB) messages, system information messages (other than, for example, MIB), and SIs.

The PDCCH may transfer DCI that is used by a scheduler of the gNB 108 to allocate both uplink and downlink resources. The DCI may also be used to provide uplink power control commands, configure a slot format, or indicate that preemption has occurred.

The gNB 108 may also transmit various reference signals to the UE 104. The reference signals may include demodulation reference signals (DMRSs) for the PBCH, PDCCH, and PDSCH. The UE 104 may compare a received version of the DMRS with a known DMRS sequence that was transmitted to estimate an impact of the propagation channel. The UE 104 may then apply an inverse of the propagation channel during a demodulation process of a corresponding physical channel transmission.

The reference signals may also include channel state information reference signals (CSI-RS). The CSI-RS may be a multi-purpose downlink transmission that may be used for CSI reporting, beam management, connected mode mobility, radio link failure detection, beam failure detection and recovery, and fine-tuning of time and frequency synchronization.

The reference signals and information from the physical channels may be mapped to resources of a resource grid. There is one resource grid for a given antenna port, subcarrier spacing configuration, and transmission direction (for example, downlink or uplink). The basic unit of an NR downlink resource grid may be a resource element, which may be defined by one subcarrier in the frequency domain and one orthogonal frequency division multiplexing (OFDM) symbol in the time domain. Twelve consecutive subcarriers in the frequency domain may compose a physical resource block (PRB). A resource element group (REG) may include one PRB in the frequency domain, and one OFDM symbol in the time domain, for example, twelve resource elements. A control channel element (CCE) may represent a group of resources used to transmit PDCCH. One CCE may be mapped to a number of REGs (for example, six REGs).

The UE 104 may transmit data and control information to the gNB 108 using physical uplink channels. Different types of physical uplink channels are possible including, for instance, a physical uplink control channel (PUCCH) and a physical uplink shared channel (PUSCH). Whereas the PUCCH carries control information from the UE 104 to the gNB 108, such as uplink control information (UCI), the PUSCH carries data traffic (e.g., end-user application data), and can carry UCI.

Data transmission on PUSCH can be non-codebook-based, where the gNB 108 indicates precoding weights for the UE 104 to use. For the gNB 108 to determine the precoding weights, the gNB 108 may have previously configured the UE 104 to transmit SRS and may have triggered the UE 104 to do so. As illustrated in FIG. 1, the gNB 108 may communicate with multiple UEs (including the UE 104 and a UE 112). The gNB 108 may configure each of such UEs 104 and 112 to use particular SRS resources such that the gNB 108 can receive SRSs transmitted by the UEs 104 and 112 to then determine uplink resource allocations for each UE.

The UE 104 and the gNB 108 may perform beam management operations to identify and maintain desired beams for transmission in the uplink and downlink directions. The beam management may be applied to both PDSCH and PDCCH in the downlink direction, and PUSCH and PUCCH in the uplink direction.

In an example, communications with the gNB 108 and/or the base station can use channels in the frequency range 1 (FR1), frequency range 2 (FR2), and/or a higher frequency range (FRH). The FR1 band includes a licensed band and an unlicensed band. The NR unlicensed band (NR-U) includes a frequency spectrum that is shared with other types of radio access technologies (RATs) (e.g., LTE-LAA, WiFi, etc.). A listen-before-talk (LBT) procedure can be used to avoid or minimize collision between the different RATs in the NR-U, whereby a device should apply a clear channel assessment (CCA) check before using the channel.

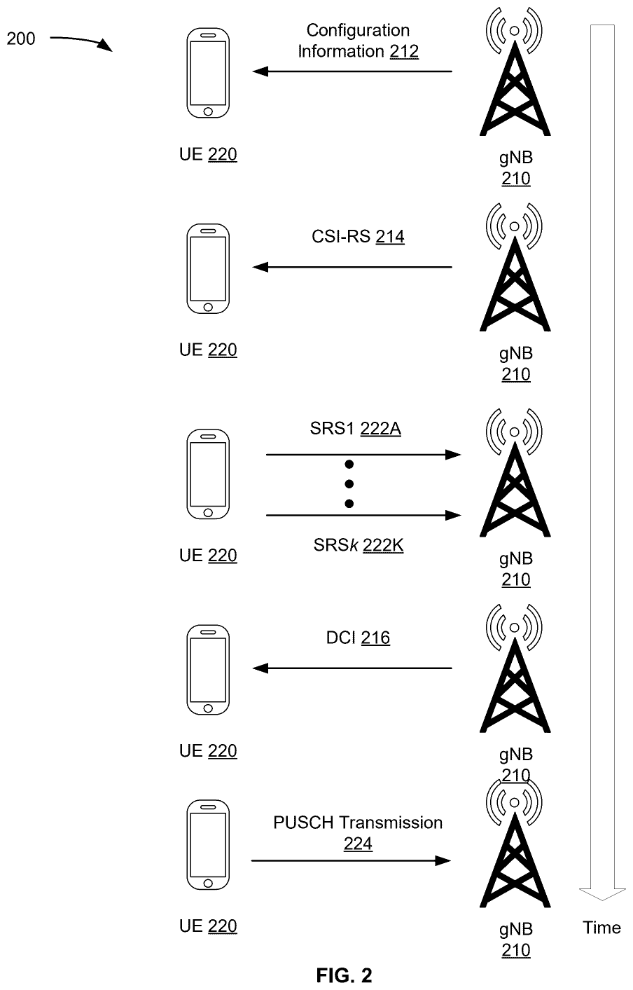

FIG. 2 illustrates an example of a non-codebook-based transmission 200 of SRSs, in accordance with some embodiments. An SRS can be used for uplink channel state estimation, allowing channel quality estimation to enable uplink link adaptation and/or frequency-selective scheduling. In the context of an uplink multiple input multiple output (MIMO) system, the SRS can also be used to determine precoders and a number of layers that provide particular throughput and/or signal to interference plus noise ratio (SINR). The SRS can be transmitted to a gNB 210 (e.g., an example of the gNB 108) from a UE 220 (e.g., an example of the UE 104) using a non-codebook-based transmission.

A non-codebook-based transmission involves the UE 220 transmitting data on an uplink channel (e.g., PUSCH) using precoding weights that the UE has generated based on downlink measurements. The non-codebook-based transmission relies on channel reciprocity because the UE 220 determines its uplink precoding weights based on the downlink measurements. The gNB 210 configures the UE 220 to use SRS resources and sends a CSI-RS for the UE to measure in order to generate the precoding weights. The UE 220 then transmits SRS using the precoding weights. In response, the gNB 210 determines PUSCH resource allocation and indicates this allocation to the UE 220 by sending DCI thereto. Thereafter, the UE 220 sends uplink traffic using the allocated PUSCH resources.

In the illustration of FIG. 2, prior to sending a CSI-RS 214, the gNB 210 configures the UE 220 to perform a non-codebook-based SRS transmission. For example, the gNB 210 sends SRS configuration information 212 to the UE 220. This configuration information 212 can be sent based on UE capability information of the UE 220 indicating that the UE 220 supports non-codebook-based SRS transmissions. The configuration information 212 indicates to the UE 220 that such transmissions are to be used. The configuration information 212 also configures the UE 220 to use an SRS resource set. This set can include a number “N” of SRS resources, where each SRS resource is configured with an antenna port (e.g., an SRS port) depending on the UE capability. When the UE 220 can support eight or more antenna ports, the number “N” can be eight or more SRS resources. Alternatively, the gNB 210 can configure multiple resource sets, where each resource set includes four SRS resources, such that the total number of configures SRS resources is “N.” In both cases, the configuration information 212 indicates that eight or more antenna ports are to be used for the non-codebook based SRS transmission.

Next, the gNB 210 sends a CSI-RS 214 to the UE 220. The UE 220 performs measurements on the CSI-RS 214 to generate precoding weights for each of the configured SRS resources. For instance, an eigen vector is calculated based on the CSI-RS using: USV^{H}=svd(H). Each row of the matrix V can be applied to generate a pre-coded SRS resource.

Based on the precoding weights and the configured SRS resources, the UE 220 transmits SRS to the gNB 210. The SRS transmission illustrated as SRS1 222A through SRSk 222K and can be responsive to a trigger of the gNB 210. For instance, the gNB 210 uses PDCCH to trigger an aperiodic transmission, a media access control (MAC) control element (CE) to activate semi-persistent SRS transmissions or a new cycle for periodic triggering, or RRC signaling to configure periodic SRS transmissions. When at least eight antenna ports are configured for use, the UE 210 can use at least eight SRS resources and the corresponding at least eight antenna ports. Typically, one SRS resource is configured for each possible layer and, hence, when eight or more SRS resources are used, the UE 220 may subsequently be indicated to use eight or more layers for the PUSCH.

Thereafter, the gNB 210 compares the received SRS transmissions to determine the number of layers for the PUSCH, and which set of pre-coded SRS should be selected for those layers. For instance, the base station may determine that eight or more layers are to be used and, hence, that a rank of eight or more (e.g., the number of layers) and that precoding applied to the corresponding eight or more of the SRS resources are to be used for the PUSCH.

The gNB 210 then sends DCI 216 to allocate PUSCH resources. The DCI indicates, directly or indirectly as further described in the next figures, a set “M” SRS resources from the “N” configured SRS resources. The DCI 216 also indicates the number of layers (or rabnk) and the specific precoding weights to be applied. Thereafter, the UE 220 uses the allocated resources to transmit PUSCH data (illustrated a PUSCH transmission 224) and other signals (e.g., DMRS) using the indicated number of layers and precoding eights.

An SRS resource can be allocated for an SRS transmission according to a number of steps, such as the steps defined in 3GPP TS 38.211, V16.8.0 (2022-01), section 6.4.1.4, the content of which is hereby incorporated by reference in its entirety. One step includes the generation of a base sequence

$${r}^{{p}_{i}} ( n , {l}^{′} ) = {r}_{u , v}^{{α}_{i} , δ} ( n ) , where n = 0 , 1 , 2 , ... {M}_{sc , b}^{SRS} - 1 ,$$

l′ is the symbol index,

$${r}_{u , v}^{{α}_{i} , δ} ( n )$$

is defined in section 5.2.2 of 3GPP TS 38.211,

$${α}_{i} = 2 π {n}_{SRS}^{cs , i} / {n}_{SRS}^{cs , max} , {n}_{SRS}^{cs , i}$$

is the cyclic shift for antenna port i, which is determined by the cyclic shift configured by RRC signaling and the port index i. The maximum number of cyclic shift

$${n}_{SRS}^{cs , max}$$

is determined by the number of comb configured by transmission comb (K_{TC}) and this association is defined in Table 6.4.1.4.2-1, copied herein below as Table 1.

TABLE 1

| K_{TC} | n_{SRS}^{cs, max} |
|---|---|
| 2 | 8 |
| 4 | 12 |
| 8 | 6 |

Another step involves resource mapping. In particular, the sequence r^{p}^{ᵢ}(n, l′) for each OFDM symbol l′ and for each of the antenna ports of the SRS resource is multiplied with the amplitude scaling factor β_{SRS} in order to conform to a particular transmit power and mapped in sequence starting with r^{p}^{ᵢ}(0, l′) r to resource elements (k, l) in a slot for each of the antenna ports pᵢ. This mapping allocates the SRS to different bandwidth (e.g., in the frequency domain) and symbols (e.g., in the time domain) based on a configured comb offset. The different antenna ports pᵢ can be differentiated by using different cyclic shifts. Generally, a uniform cyclic shift is used for an antenna port (e.g., a uniform distribution of the

$${n}_{SRS}^{cs , i}$$

across the antenna ports pᵢ) to have a good separation between the antenna ports. Further instance, and referring back to Table 1, for a four-antenna port case, the second and fourth antenna ports may take different comb offset when the cyclic shift offset is configured to be larger than half the maximum cyclic shift compared to the first and third antenna ports. Additionally, frequency hopping can be enabled to transmit SRS in different symbols with different frequency domain location so that gNB 210 can get a wider bandwidth uplink channel, which in turn can improve the gNB's 210 estimation of the uplink channel.

Challenges arise when, for example, the number “N” of configured SRS resources is eight or more. In particular, some of the challenges relate to the size of the DCI 216. If the DCI 216 is to indicate directly the SRI, eight or more bits may be needed for this indication because the gNB 210 may determine that the rank is eight or more. As such, at least eight bits would been needed to support the different possible SRIs. Embodiments of the present disclosure enable the use of a DCI with a relatively reduced size (e.g., less than eight bits are needed) while also enabling a configuration of “N” SRS resources, where “N” is equal to or larger than eight.

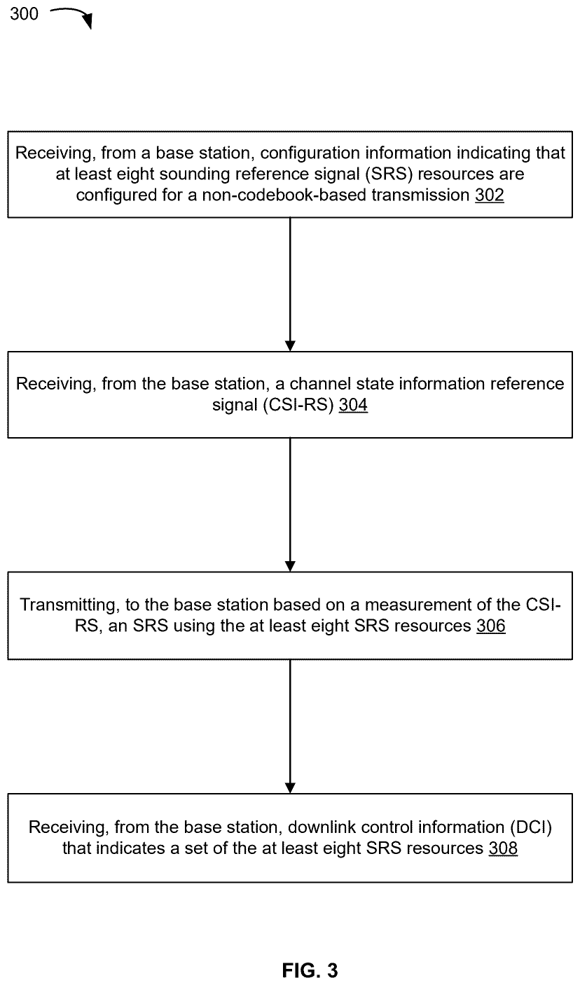

FIG. 3 illustrates an example of an operational flow/algorithmic structure 300 for UE using a non-codebook-based transmission of SRSs, in accordance with some embodiments. The UE is an example of the UE 104, the UE 220, or the UE 1000. Portions or the entirety of the operational flow/algorithmic structure 300 can be implemented as part of the SRS non-codebook-based SRS transmission 200.

In an example, the operational flow/algorithmic structure 300 may include, at 302, receiving, from a base station, configuration information indicating that at least eight SRS resources are configured for a non-codebook-based transmission. For instance, the configuration information 212 is received via RRC signaling.

In an example, the operational flow/algorithmic structure 300 may include, at 304, receiving, from the base station, a CSI-RS. For instance, the CSI-RS is triggered by the PDCCH.

In an example, the operational flow/algorithmic structure 300 may include, at 306, transmitting, to the base station based on a measurement of the CSI-RS, an SRS using the at least eight SRS resources. For instance, the two steps described herein above are performed to send the SRS using at least eight antenna ports, where each antenna port is associated with one of the configured SRS resources.

In an example, the operational flow/algorithmic structure 300 may include, at 308, receiving, from the base station, DCI that indicates a set of the at least eight SRS resources. For instance, the DCI is received on the PDCCH. Whereas “N” SRS resources are configured (where “N” is equal to or larger than eight), “M” SRS resources are indicated in the DCI (where “M” is equal to or smaller than “N”). Each one of the “M” SRS resources corresponds to a layer and, hence, the DCI indicates “M” layers for the uplink transmission. The DCI also indicates precoding weights for use, where these weights correspond to the “M” SRS resources. To reduce the size of the DCI, rather than indicating the SRI directly, the DCI indicates a number of demodulation reference signal (DMRS) ports, where this number is associated with a corresponding SRI in a predefined manner. In another example, the DCI indicates a number of DMRS ports, and this number is associated with a number of SRI combinations. In this case, the DCI can also indicate an SRI for a selection of a corresponding SRI combination. In yet another example, the UE may report possible SRI combinations for each number of DMRS ports (e.g., as part of its UE capability). In this example, the DCI can indicate one of the numbers of DMRS ports and/or an SRI corresponding to one of the possible SRI combinations. In a further example, an SRI indicated in first DCI having a first format can be based on SRS resources configured for second DCI having a second format.

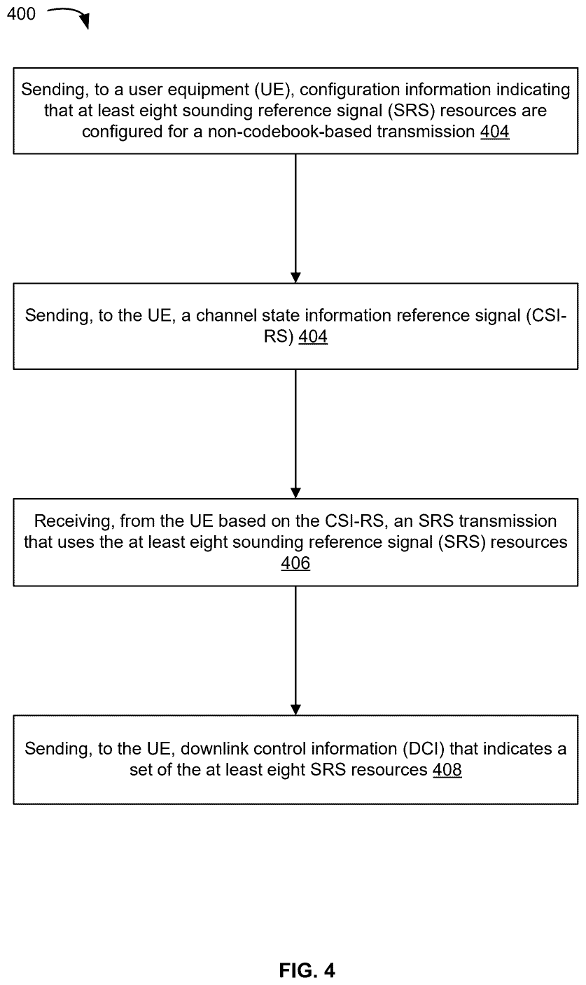

FIG. 4 illustrates an example of an operational flow/algorithmic structure 400 for a base station using a non-codebook-based transmission of SRSs, in accordance with some embodiments. The base station is an example of the the gNB 108, the gNB 210, or the gNB 1100. Portions or the entirety of the operational flow/algorithmic structure 400 can be implemented as part of the SRS non-codebook-based SRS transmission 200.

In an example, the operational flow/algorithmic structure 400 may include, at 402, sending, to a UE, configuration information indicating that at least eight SRS resources are configured for a non-codebook-based transmission. For instance, the configuration information 212 is sent via RRC signaling.

In an example, the operational flow/algorithmic structure 400 may include, at 404, sending, to the UE, a CSI-RS. For instance, the CSI-RS is triggered by the PDCCH.

In an example, the operational flow/algorithmic structure 400 may include, at 406, receiving, from the UE based on the CSI-RS, an SRS transmission that uses the at least eight sounding reference signal (SRS) resources. For instance, the two steps described herein above are performed by the UE to send the SRS using at least eight antenna ports, where each antenna port is associated with one of the configured SRS resources. The base station receives the transmitted SRS on an uplink channel (e.g., PUSCH).

In an example, the operational flow/algorithmic structure 400 may include, at 408, sending, to the UE, DCI that indicates a set of the at least eight SRS resources. For instance, the DCI is sent on the PDCCH. Whereas “K” SRS resources are configured (where “K” is equal to or larger than eight), “M” SRS resources are indicated in the DCI (where “M” is equal to or smaller than “N”). Each one of the “M” SRS resources corresponds to a layer and, hence, the DCI indicates “M” layers for the uplink transmission. The DCI also indicates precoding weights for use, where these weights correspond to the “M” SRS resources. To reduce the size of the DCI, rather than indicating the SRI directly, the DCI indicates a number of demodulation reference signal (DMRS) ports, where this number is associated with a corresponding SRI in a predefined manner. In another example, the DCI indicates a number of DMRS ports, and this number is associated with a number of SRI combinations. In this case, the DCI can also indicate an SRI for a selection of a corresponding SRI combination. In yet another example, the UE may report possible SRI combinations for each number of DMRS ports (e.g., as part of its UE capability). In this example, the DCI can indicate one of the numbers of DMRS ports and/or an SRI corresponding to one of the possible SRI combinations. In a further example, an SRI indicated in first DCI having a first format can be based on SRS resources configured for second DCI having a second format.

Based on a received CSI-RS, a UE can determine a pre-coded weight to use for each configured SRS resource. The pre-coded weights can be determined by calculating an eigen vector. Accordingly, information is available to the UE about which SRS resource should provide the best performance for each layer. In particular, the first row in the eigen vector could provide the best performance for a single layer transmission, the first row and the second row in the eigen vector could provide the best performance for a two-layer transmission, and so on. This type of UE-known information can be taken advantage of to reduce the size of DCI used for the PUSCH resource allocation as further illustrated in the next figures.

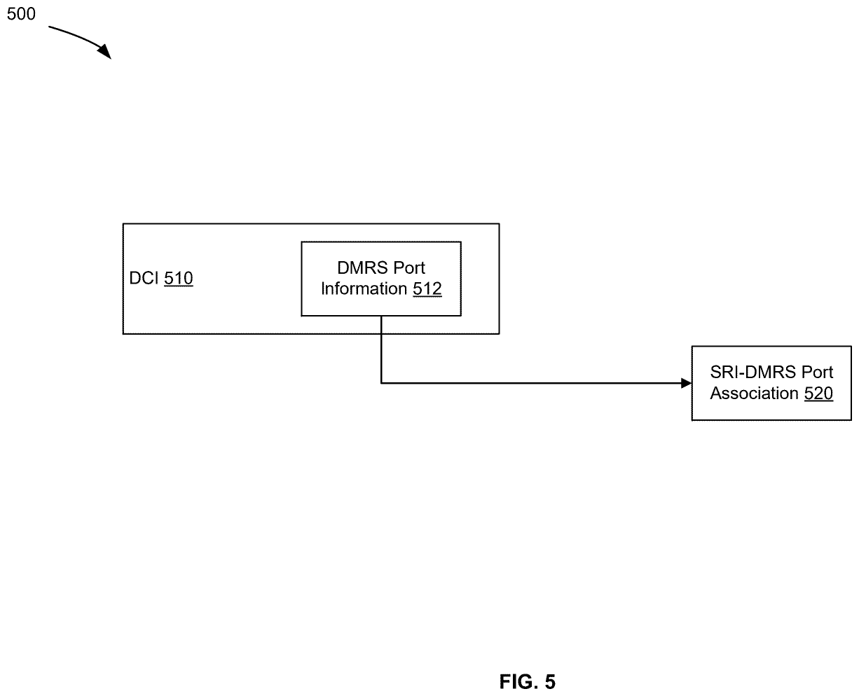

FIG. 5 illustrates an example of using 500 DCI 510 for a non-codebook-based SRS transmission, in accordance with some embodiments. Typically, there is a one-to-one mapping between an SRS resource and an a specific DMRS, whereby precoding applied to the SRS resource is also applicable to the corresponding DMRS. Hence, rather than indicating the SRI (e.g., an indicator of SRS resource(s)), the DCI 510 includes DMRS port information 512. This information 512 can indicate the DMRS ports and/or the number of DMRS ports. This number corresponds to the number of layers to use for the PUSCH transmission. The UE may store an SRI-DMRS port association 520 (e.g., a mapping between an SRI to a corresponding set of DMRS ports). This SRI-DMRS port association 520 can be predefined or can be received from the base station via RRC signaling or a media access control (MAC) control element (CE). Given the DMRS port information 512, the UE can look up the SRI-DRM port association 520 and determine the corresponding SRI to use.

In an example, the first SRS resource (and a corresponding first SRI that supports a single layer transmission) is mapped to a one DMRS port case. In comparison, the first two SRS resources (and a corresponding second SRI that supports a two-layer transmission) is mapped to a two DMRS port case, and so on. This example reflects the eigen vector best performance approach described herein above.

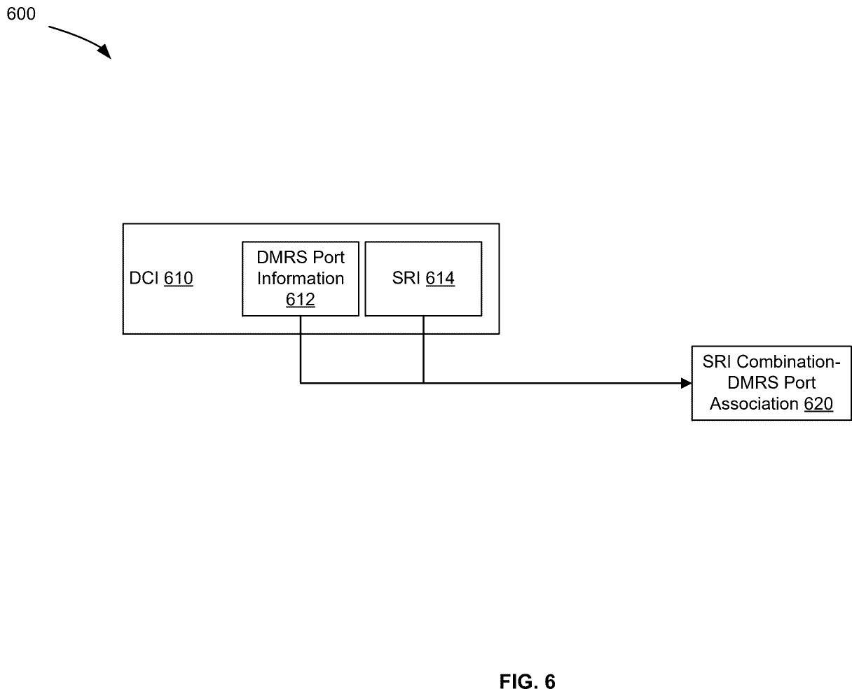

FIG. 6 illustrates another example of using 600 DCI 610 for a non-codebook-based SRS transmission, in accordance with some embodiments. Unlike FIG. 5, here each number of DMRS ports can be mapped to more than one SRI combination. For instead, a one DMRS port case can be mapped to a first set of SRI combinations, a two DMRS port case can be mapped to a second set of SRI combinations, and so on. The sizes of the sets can be different or can be the same. An example of such mapping is further shown in Tables 2 and 3 below, where each set of SRI combinations includes two combinations as in Table 2 or a has a different size as in Table 3. The DMRS port number(s) to SRI combinations approach may give the base station some flexibility for interference management (e.g., related to communications with other UEs) and for the case when the associated CSI-RS is not configured. In particular, each mapping can correspond to a particular combination of eigen vector rows to reflect this flexibility. Because the number of DMRS ports can be mapped to more than one SRI combination, the base station may still need to indicate the SRI in the DCI to select one of the SRI combinations (e.g., the SRI indicates an SRI combination rather than a particular SRI). However, the overall size of the DCI is relatively reduced.

In the illustration of FIG. 6, DCI 610 includes DMRS port information 612 (similar to the DMRS port information 512) and/or SRI 614 that indicates an SRI combination. The UE also stores SRI combination-DMRS port association 620 (e.g., a mapping between an SRI combination(s) to a corresponding DMRS port). This SRI combination-DMRS port association 620 can be predefined or can be received from the base station via RRC signaling or a MAC CE.

In an example, the base station includes the DMRS port information 612 but not the SRI 614 in the DCI 610. In this example, the DMRS port information 612 can indicate a number of DMRS ports (e.g., corresponding to a number of layers or a rank to use). This number can be used in a look up of the SRI combination-DMRS port association 620. The UE then determines the corresponding set of SRI combinations. This set can include multiple SRI combinations. If so, the UE be configured with a rule usable to select a particular SRI combination to use. As such, the UE determines the number of layers for the transmission (corresponding to the number of DMRS ports) and uses the SRIs indicated in the SRI combination for the transmission.

In an example, the base station includes the SRI 614 but not the DMRS port information 614 in the DCI 610. In this example, the SRI 614 can be used to select an SRI combination. In particular, the SRI 614 can indicate the SRI combination and this SRI combination is used in a look up of the SRI combination-DMRS port association 620. The look up may result in a number DMRS ports being identified. This identified number corresponds to the number of layers to be used in the transmission. The SRIs indicated in the SRI combination are also used for the transmission. In this example, the size of the SRI field in the DCI 610 can be based on the total number of SRI combinations for all the ranks (e.g., across the possible numbers of DMRS ports).

In yet another example, the base station includes the DMRS port information 612 and the SRI 614 in the DCI 610. In this example, the DMRS port information 612 can indicate a number of DMRS ports (e.g., corresponding to a number of layers or a rank to use). This number can be used in a look up of the SRI combination-DMRS port association 620. As a result of the look up, the UE determines the corresponding set of SRI combinations. The SRI 614 is then used to select one of the SRI combinations (e.g., assuming two SRI combinations are determined, the SRI 614 can be one bit long, where a “0” bit indicates that the first SRI combination is to be used, and a “1” bit indicates that the second SRI combination is to be used).

Further, in one example, the base station 6110 can configure, in the SRI combination-DMRS port association 620, how many combinations should be considered by the UE for each number or across all number of DMRS ports (e.g. RRC signaling for SRI restriction can be used). The use of this example is illustrated in Table 2 below. In another example, the base station can configure, in the SRI combination-DMRS port association 620, the exact SRI(s) or candidate SRS resources for each number of DMRS ports (e.g., by RRC signaling). The use of this example is illustrated in Table 3 below.

TABLE 2

| Number of DMRS Ports | SRS Combinations |
|---|---|
| 1 | SRI {1}, {2} |
| 2 | SRI {1, 2}, {2, 3} |
| 3 | SRI {1, 2, 3}, {3, 4, 5} |
| 4 | SRI {1, 2, 3, 4}, {3, 4, 5, 6} |
| 5 | SRI {1, 2, 3, 4, 5}, {3, 4, 5, 6, 7} |
| 6 | SRI {1, 2, 3, 4, 5, 6}, {3, 4, 5, 6, 7, 8} |
| 7 | SRI {1, 2, 3, 4, 5, 6, 7}, {2, 3, 4, 5, 6, 7, 8} |
| 8 | SRI {1, 2, 3, 4, 5, 6, 7, 8}, {reserved} |

In Table 2 above, the size of the SRI 614 is four bits, to indicate sixteen SRI combinations (e.g., two combinations per number of DMRS ports). When the SRI 614 is set to, for instance, “0000,” this SRI value indicates the first combination {1}. Here, the UE can determine that the number of DRMS ports is one (e.g., corresponding to a single layer transmission) and that SRI “1” is to be used for the single layer transmission. In comparison, if the SRI 614 was set to “0001,” this value indicates the second combination {2} and the UE can determine that a single layer transmission is to be performed based on SRI “2.” In a further comparison, when the SRI 614 is set to, for instance, “0010,” the third combination {1, 2} is indicated and is associated with the number of DMRS ports of two. As such, the UE can determine SRI “1” and SRI “2” are to be used for the two-layer transmission.

Table 3 below illustrates another example. Here, the base station can configure the exact set of SRIs or candidate SRS resources for number of DMRS port.

TABLE 3

| Number of DMRS | | Number of SRI |
|---|---|---|
| Ports | Candidate SRS resources | combinations |
| 1 | SRS 1, 2, 3, 4, 5, 6 | 6 |
| 2 | SRS 1, 2, 3, 4 | 6 |
| 3 | SRS 1, 2, 3, 4 | 4 |
| 4 | SRS 1, 2, 3, 4, 5 | 5 |
| 5 | SRS 1, 2, 3, 4, 5, 6 | 6 |
| 6 | SRS 1, 2, 3, 4, 5, 6 | 1 |
| 7 | SRS 1, 2, 3, 4, 5, 6, 7 | 1 |
| 8 | SRS 1, 2, 3, 4, 5, 6, 7, 8 | 1 |

In Table 3 above, a total of thirty SRI combinations are supported, where, for example, the number of DMRS ports of one corresponds to six SRI combinations, whereas the number of DMRS ports of eight corresponds to a single SRI combination. As such, the size of the SRI 614 is five bits to indicate these thirty combinations. When the SRI 614 is set to, for instance, “00000,” and the number of DMRS ports is indicated to be one, the UE can determine that the SRS resource “1” is to be used. In comparison, when the SRI 614 is set to, for instance, “00001,” and the number of DMRS ports is indicated to be one, the UE can determine that the SRS resource “2” is to be used, and so on.

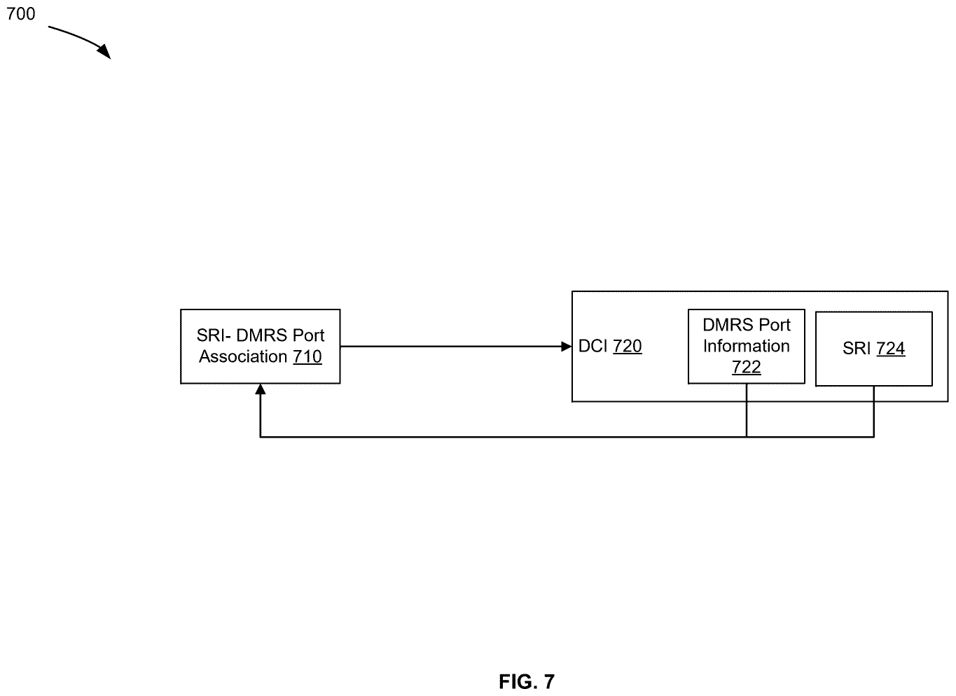

FIG. 7 illustrates an example of reporting 700 SRI combinations in support of a DCI transmission, in accordance with some embodiments. Here, unlike FIG. 6 where a base station configures SRI combinations for a UE depending on a number of DMRS ports (or, equivalently, the rank), the UE can indicate to the base state possible SRIs for each rank. The UE may report possible SRI combinations for each number of DMRS ports. This approach is similar to what is shown in Table 2 above, except that the UE may be reporting this information. Alternatively or additionally, the UE may report the possible number of SRI combinations for each number of DMRS ports. This approach is similar to what is shown in Table 3 above, except that the UE may be reporting this information. In both situations, the reported information may be sent in UE capability information (e.g., prior to the configuration information 212 being received) or dynamically reported by being included in uplink control information (UCI) in PUCCH or PUSCH, or by being included in a MAC CE. When sending DCI to the UE, the base station can send DMRS port information and/or SRI as described in FIG. 6.

In the illustration of FIG. 7, the UE can report SRI-DMRS port association 710 to the base station. In one example, the SRI-DMRS port association 710 indicates the possible SRI combinations for each number of DMRS ports. In another example, the SRI-DMRS port association 710 indicates the possible number of SRI combinations for each number of DMRS ports. The SRI-DMRS port association 710 can be stored by the base station, in addition to being stored by the UE. In turn, the UE sends DCI 720 that includes DMRS port information (similar to the DMRS port information 512) and SRI 724 (similar to the SRI 614). The UE can then send its own locally stored SRI-DMRS port association 710 to determine the resources to be used for the uplink transmission.

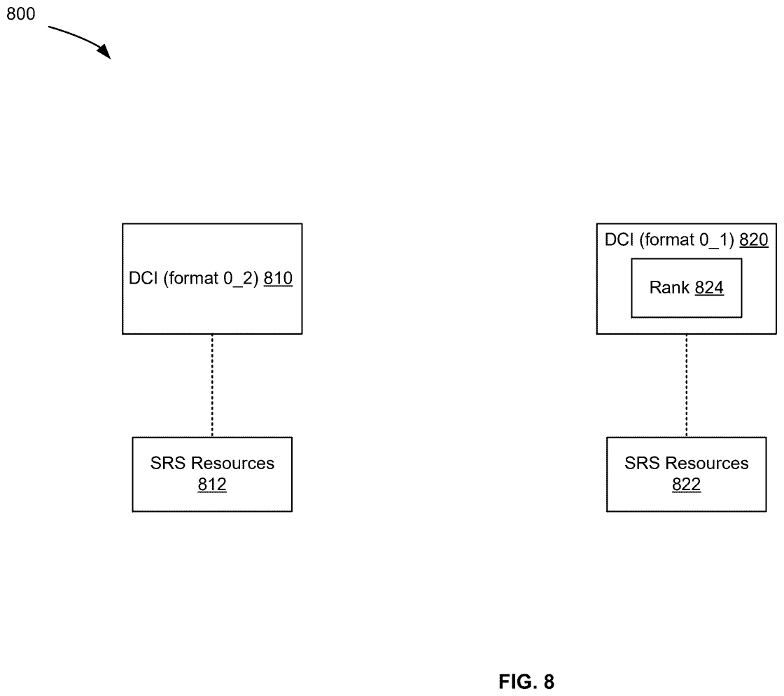

FIG. 8 illustrates an example of using 800 multiple DCIs for a non-codebook-based SRS transmission, in accordance with some embodiments. In an example, a first DCI 820 having a first format (e.g., format 0_2) and a second DCI 820 having a second format (e.g., format 0_1) are used. An SRI that is for a rank equal to or smaller than a certain rank threshold “X” that is indicated by the second DCI 820 can be based on the SRS resources configured for the first DCI 810. For example, “X” is equal to the number of first SRS resources 812 in a first resource set configured for the first DCI 810. Second SRS resources 822 in a second resource set can be configured for the second DCI 820. These two sets of SRS resources can be configured by the base station for a UE (e.g., as part of the configuration 212). Once the UE performs the SRS transmission and the base station receives such transmission, the base station can send the second DCI 820 to the UE for the uplink resource allocation. Here, the DCI can indicate a rank 824. The UE can compare the rank 824 to the rank threshold “X.” If the rank 824 is smaller than or equal to “X,” the second DCI 820 indicates the first SRS resource 812. Otherwise, the second DCI 820 indicates the second SRS resources 822. Here, the rank can be indicated in an SRI field of the second DCI 820. The size of this field can be based on the total number of SRI combination for all ranks (e.g., across the different numbers of DMRS ports).

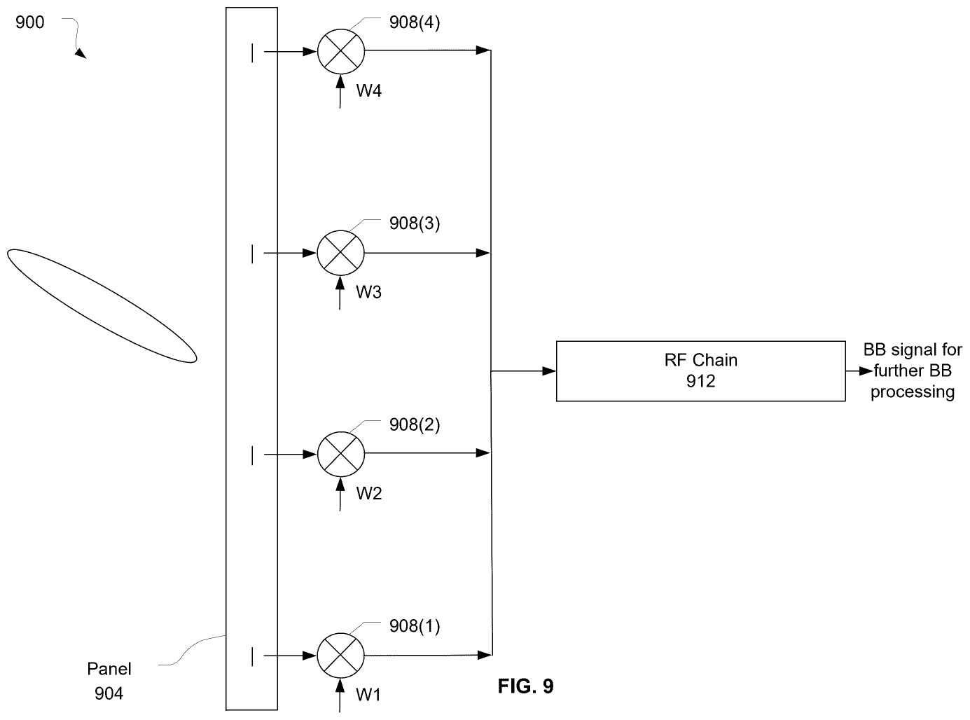

FIG. 9 illustrates receive components 900 of the UE 104, in accordance with some embodiments. The receive components 900 may include an antenna panel 904 that includes a number of antenna elements. The panel 904 is shown with four antenna elements, but other embodiments may include other numbers.

The antenna panel 904 may be coupled to analog beamforming (BF) components that include a number of phase shifters 908(1)-908(4). The phase shifters 908(1)-908(4) may be coupled with a radio-frequency (RF) chain 912. The RF chain 912 may amplify a receive analog RF signal, downconvert the RF signal to baseband, and convert the analog baseband signal to a digital baseband signal that may be provided to a baseband processor for further processing.

In various embodiments, control circuitry, which may reside in a baseband processor, may provide BF weights (for example W1-W4), which may represent phase shift values, to the phase shifters 908(1)-908(4) to provide a receive beam at the antenna panel 904. These BF weights may be determined based on the channel-based beamforming.

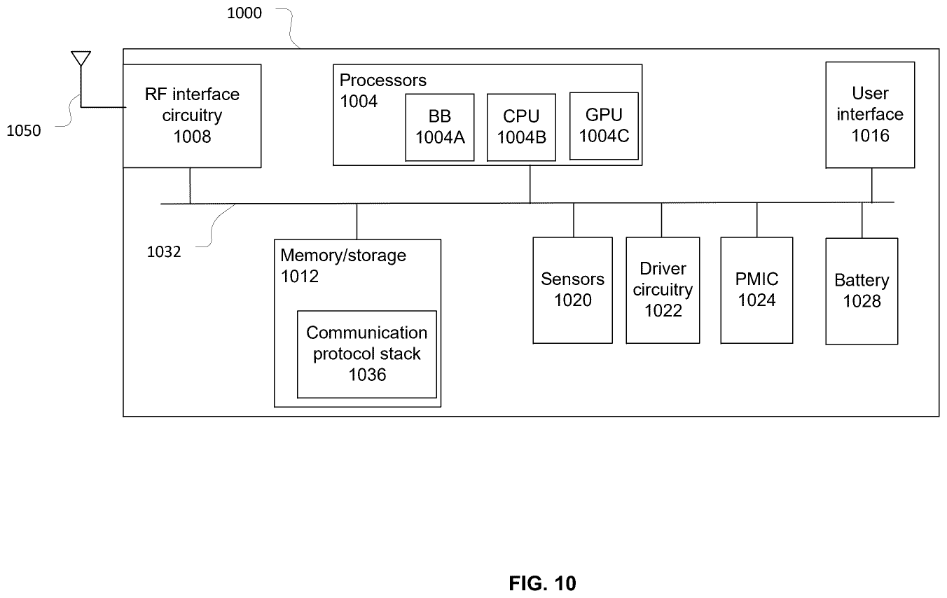

FIG. 10 illustrates a UE 1000, in accordance with some embodiments. The UE 1000 may be similar to and substantially interchangeable with UE 104 of FIG. 1.

Similar to that described above with respect to UE 104, the UE 1000 may be any mobile or non-mobile computing device, such as mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the UE may be a reduced capacity UE or NR-Light UE.

The UE 1000 may include processors 1004, RF interface circuitry 1008, memory/storage 1012, user interface 1016, sensors 1020, driver circuitry 1022, power management integrated circuit (PMIC) 1024, and battery 1028. The components of the UE 1000 may be implemented as integrated circuits (ICs), portions thereof, discrete electronic devices, or other modules, logic, hardware, software, firmware, or a combination thereof. The block diagram of FIG. 10 is intended to show a high-level view of some of the components of the UE 1000. However, some of the components shown may be omitted, additional components may be present, and different arrangements of the components shown may occur in other implementations.

The components of the UE 1000 may be coupled with various other components over one or more interconnects 1032, which may represent any type of interface, input/output, bus (local, system, or expansion), transmission line, trace, optical connection, etc. that allows various circuit components (on common or different chips or chipsets) to interact with one another.

The processors 1004 may include processor circuitry, such as baseband processor circuitry (BB) 1004A, central processor unit circuitry (CPU) 1004B, and graphics processor unit circuitry (GPU) 1004C. The processors 1004 may include any type of circuitry or processor circuitry that executes or otherwise operates computer-executable instructions, such as program code, software modules, or functional processes from memory/storage 1012 to cause the UE 1000 to perform operations as described herein.

In some embodiments, the baseband processor circuitry 1004A may access a communication protocol stack 1036 in the memory/storage 1012 to communicate over a 3GPP compatible network. In general, the baseband processor circuitry 1004A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1008.

The baseband processor circuitry 1004A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The baseband processor circuitry 1004A may also access group information from memory/storage 1012 to determine search space groups in which a number of repetitions of a PDCCH may be transmitted.

The memory/storage 1012 may include any type of volatile or non-volatile memory that may be distributed throughout the UE 1000. In some embodiments, some of the memory/storage 1012 may be located on the processors 1004 themselves (for example, L1 and L2 cache), while other memory/storage 1012 is external to the processors 1004 but accessible thereto via a memory interface. The memory/storage 1012 may include any suitable volatile or non-volatile memory, such as, but not limited to, dynamic random-access memory (DRAM), static random-access memory (SRAM), erasable programmable read-only memory (EPROM), electrically erasable programmable read-only memory (EEPROM), Flash memory, solid-state memory, or any other type of memory device technology.

The RF interface circuitry 1008 may include transceiver circuitry and a radio frequency front module (RFEM) that allows the UE 1000 to communicate with other devices over a radio access network. The RF interface circuitry 1008 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 1050 and proceed to filter and amplify (with a low-noise amplifier) the signal. The signal may be provided to a receiver of the transceiver that down-converts the RF signal into a baseband signal that is provided to the baseband processor of the processors 1004.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1050.

In various embodiments, the RF interface circuitry 1008 may be configured to transmit/receive signals in a manner compatible with NR access technologies.

The antenna 1050 may include a number of antenna elements that each convert electrical signals into radio waves to travel through the air and to convert received radio waves into electrical signals. The antenna elements may be arranged into one or more antenna panels. The antenna 1050 may have antenna panels that are omnidirectional, directional, or a combination thereof to enable beamforming and multiple input, multiple output communications. The antenna 1050 may include microstrip antennas, printed antennas fabricated on the surface of one or more printed circuit boards, patch antennas, phased array antennas, etc. The antenna 1050 may have one or more panels designed for specific frequency bands including bands in FR1 or FR2.

The user interface circuitry 1016 includes various input/output (I/O) devices designed to enable user interaction with the UE 1000. The user interface 1016 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators, such as light emitting diodes (LEDs) and multi-character visual outputs, or more complex outputs, such as display devices or touchscreens (for example, liquid crystal displays (LCDs), LED displays, quantum dot displays, projectors, etc.), with the output of characters, graphics, multimedia objects, and the like being generated or produced from the operation of the UE 1000.

The sensors 1020 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1022 may include software and hardware elements that operate to control particular devices that are embedded in the UE 1000, attached to the UE 1000, or otherwise communicatively coupled with the UE 1000. The driver circuitry 1022 may include individual drivers allowing other components to interact with or control various input/output (I/O) devices that may be present within, or connected to, the UE 1000. For example, driver circuitry 1022 may include a display driver to control and allow access to a display device, a touchscreen driver to control and allow access to a touchscreen interface, sensor drivers to obtain sensor readings of sensor circuitry 1020 and control and allow access to sensor circuitry 1020, drivers to obtain actuator positions of electro-mechanic components or control and allow access to the electro-mechanic components, a camera driver to control and allow access to an embedded image capture device, audio drivers to control and allow access to one or more audio devices.

The PMIC 1024 may manage power provided to various components of the UE 1000. In particular, with respect to the processors 1004, the PMIC 1024 may control power-source selection, voltage scaling, battery charging, or DC-to-DC conversion.

In some embodiments, the PMIC 1024 may control, or otherwise be part of, various power saving mechanisms of the UE 1000. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1000 may power down for brief intervals of time and thus save power. If there is no data traffic activity for an extended period of time, then the UE 1000 may transition off to an RRC_Idle state, where it disconnects from the network and does not perform operations, such as channel quality feedback, handover, etc. The UE 1000 goes into a very low power state and it performs paging where again it periodically wakes up to listen to the network and then powers down again. The UE 1000 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1028 may power the UE 1000, although in some examples the UE 1000 may be mounted deployed in a fixed location and may have a power supply coupled to an electrical grid. The battery 1028 may be a lithium-ion battery, a metal-air battery, such as a zinc-air battery, an aluminum-air battery, a lithium-air battery, and the like. In some implementations, such as in vehicle-based applications, the battery 1028 may be a typical lead-acid automotive battery.

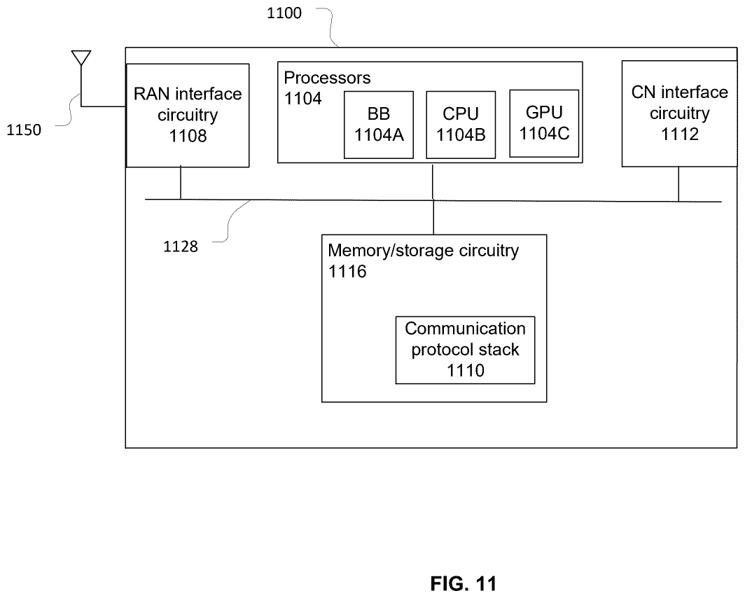

FIG. 11 illustrates a gNB 1100, in accordance with some embodiments. The gNB 1100 may be similar to and substantially interchangeable with the gNB 108 of FIG. 1.

The gNB 1100 may include processors 1104, RAN interface circuitry 1108, core network (CN) interface circuitry 1112, and memory/storage circuitry 1116.

The components of the gNB 1100 may be coupled with various other components over one or more interconnects 1128.

The processors 1104, RAN interface circuitry 1108, memory/storage circuitry 1116 (including communication protocol stack 1110), antenna 1150, and interconnects 1128 may be similar to like-named elements shown and described with respect to FIG. 10.

The CN interface circuitry 1112 may provide connectivity to a core network, for example, a Fifth Generation Core network (5GC) using a 5GC-compatible network interface protocol, such as carrier Ethernet protocols, or some other suitable protocol. Network connectivity may be provided to/from the gNB 1100 via a fiber optic or wireless backhaul. The CN interface circuitry 1112 may include one or more dedicated processors or FPGAs to communicate using one or more of the aforementioned protocols. In some implementations, the CN interface circuitry 1112 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 includes a method implemented by a user equipment (UE), the method comprising: receiving, from a base station, configuration information indicating that at least eight sounding reference signal (SRS) resources are configured for a non-codebook-based transmission; receiving, from the base station, a channel state information reference signal (CSI-RS); transmitting, to the base station based on a measurement of the CSI-RS, an SRS using the at least eight SRS resources; and receiving, from the base station, downlink control information (DCI) that indicates a set of the at least eight SRS resources.

Example 2 includes the method of example 1, wherein the DCI indicates a number of demodulation reference signal (DMRS) ports, and wherein method further comprises: determining an SRS resource indicator (SRI) based on a predefined SRI-DMRS port association; and determining the set of the at least eight SRS resources based on the SRI.

Example 3 includes the method of example 2, wherein the predefined SRI-DMRS port association indicates for each possible number of DMRS ports a corresponding set of SRS resources.

Example 4 includes the method of any preceding examples, wherein the DCI indicates an SRS resource indicator (SRI) that corresponds to an SRI combination, and wherein the method further comprises: determining a number of demodulation reference signal (DMRS) ports associated with the SRI combination; and determining the set of resources based on the number of DMRS ports.

Example 5 includes the method of example 4, wherein the number of DMRS ports is determined based on an SRI combination-DMRS port association.

Example 6 includes the method of example 5, wherein the SRI combination-DMRS port association indicates for each possible number of DMRS ports or for all possible numbers of DMRS ports a corresponding SRI combination.

Example 7 includes the method of example 5, wherein the SRI combination-DMRS port association indicates for each possible number of DMRS ports a corresponding set of SRIs or a corresponding set of candidate SRS resources.

Example 8 includes the method of example 5, wherein the SRI combination-DMRS port association is predefined or is indicated by the base station to the UE based on radio resource control (RCC) signaling or a media access control (MAC) control element (CE).

Example 9 includes the method of example 5, wherein the SRI is included in an SRI field of the DCI, and wherein a size of the SRI field is based on a total number of SRI combination for all ranks usable for the non-codebook based transmission.

Example 10 includes the method of any preceding examples, further comprising: indicating, to the base station, for each possible number of demodulation reference signal (DMRS) ports a corresponding SRS resource indicator (SRI) combination.

Example 11 includes the method of example 10, wherein the DCI indicates a number of DMRS ports or an SRI, and wherein method further comprises: determining the set of the at least eight SRS resources based on the number of DMRS ports or the SRI.

Example 12 includes the method of any preceding examples, further comprising: indicating, to the base station, for each possible number of demodulation reference signal (DMRS) ports a corresponding number of SRS resource indicator (SRI) combinations.

Example 13 includes the method of any preceding examples, further comprising: determining an SRS resource indicator (SRI) based on the DCI; and determining the set of the at least eight SRS resources based on the SRI, wherein the SRI is associated with a rank smaller than or equal to “X,” wherein “X” is a positive integer, wherein the DCI has a first DCI format, and wherein the SRI is based on SRS resources configured for a second DCI format.

Example 14 includes the method of example 13, wherein “X” is equal to a number of SRS resources in a resource set configured for the second DCI format.

Example 15 includes the method of any preceding examples, further comprising: determining an SRS resource indicator (SRI) based on the DCI; and determining the set of the at least eight SRS resources based on the SRI, wherein the SRI is associated with a rank larger than “X,” wherein “X” is a positive integer, wherein the DCI has a first DCI format, and wherein the SRI indicates SRS resources configured for the first DCI format.

Example 16 includes the method of any preceding examples, further comprising: sending, to the base station, an indication, for each possible number of demodulation reference signal (DMRS) ports, of a corresponding number of SRS resource indicator (SRI) combinations, wherein the indication is sent based on based on UE capability information, uplink control information, or a media access control (MAC) control element (CE).

Example 17 includes a method implemented by a base station, the method comprising: sending, to a user equipment (UE), configuration information indicating that at least eight sounding reference signal (SRS) resources are configured for a non-codebook-based transmission; sending, to the UE, a channel state information reference signal (CSI-RS); receiving, from the UE based on the CSI-RS, an SRS transmission that uses the at least eight sounding reference signal (SRS) resources; and sending, to the UE, downlink control information (DCI) that indicates a set of the at least eight SRS resources.

Example 18 includes the method of example 17, further comprising: sending, to the UE, an SRS resource indicator (SRI) combination-DMRS port association based on radio resource control (RCC) signaling or a media access control (MAC) control element (CE), wherein the DCI indicates an SRI for a selection by the UE of an SRI combination.

Example 19 includes the method of example 17 or 18, wherein the DCI indicates a number of demodulation reference signal (DMRS) ports, and wherein the number of DMRS ports is pre-associated with an SRS resource indicator (SRI).

Example 20 includes a UE comprising means to perform one or more elements of a method described in or related to any of the examples 1-16.

Example 21 includes one or more non-transitory computer-readable media comprising instructions to cause a UE, upon execution of the instructions by one or more processors of the UE, to perform one or more elements of a method described in or related to any of the examples 1-16.

Example 22 includes a UE comprising logic, modules, or circuitry to perform one or more elements of a method described in or related to any of the examples 1-16.

Example 23 includes a UE comprising: one or more processors and one or more computer-readable media comprising instructions that, when executed by the one or more processors, cause the one or more processors to perform one or more elements of a method described in or related to any of the examples 1-16.

Example 24 includes a system comprising means to perform one or more elements of a method described in or related to any of the examples 1-16.

Example 25 includes a network comprising means to perform one or more elements of a method described in or related to any of the examples 17-19.

Example 26 includes one or more non-transitory computer-readable media comprising instructions to cause a network, upon execution of the instructions by one or more processors of the network, to perform one or more elements of a method described in or related to any of the examples 17-19.

Example 27 includes a network comprising logic, modules, or circuitry to perform one or more elements of a method described in or related to any of the examples 17-19.

Example 28 includes a network comprising: one or more processors and one or more computer-readable media comprising instructions that, when executed by the one or more processors, cause the one or more processors to perform one or more elements of a method described in or related to any of the examples 17-19.

Example 29 includes a system comprising means to perform one or more elements of a method described in or related to any of the examples 17-19.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1. An apparatus comprising:
processing circuitry to:
process configuration information received from a base station and indicating that at least eight sounding reference signal (SRS) resources are configured for a non-codebook-based transmission;
process a channel state information reference signal (CSI-RS) received from the base station;
generate, for transmission to the base station and based on a measurement of the CSI-RS, an SRS using the at least eight SRS resources; and
process downlink control information (DCI) received from the base station and indicating a set of the at least eight SRS resources; and
interface circuitry coupled with the processing circuitry to enable communication.

2. The apparatus of claim 1, wherein the DCI indicates a number of demodulation reference signal (DMRS) ports, and wherein the processing circuitry is further configured to:
determine an SRS resource indicator (SRI) based on a predefined SRI-DMRS port association; and
determine the set of the at least eight SRS resources based on the SRI.

3. The apparatus of claim 2, wherein the predefined SRI-DMRS port association indicates for each possible number of DMRS ports a corresponding set of SRS resources.

4. The apparatus of claim 1, wherein the DCI indicates an SRS resource indicator (SRI) that corresponds to an SRI combination, and wherein the processing circuitry is further configured to:
determine a number of demodulation reference signal (DMRS) ports associated with the SRI combination; and
determine the set of resources based on the number of DMRS ports.

5. The apparatus of claim 4, wherein the number of DMRS ports is determined based on an SRI combination-DMRS port association.

6. The apparatus of claim 5, wherein the SRI combination-DMRS port association indicates for each possible number of DMRS ports or for all possible numbers of DMRS ports a corresponding SRI combination.

7. The apparatus of claim 5, wherein the SRI combination-DMRS port association indicates for each possible number of DMRS ports a corresponding set of SRIs or a corresponding set of candidate SRS resources.

8. The apparatus of claim 5, wherein the SRI combination-DMRS port association is predefined or is indicated by the base station based on radio resource control (RCC) signaling or a media access control (MAC) control element (CE).

9. The apparatus of claim 5, wherein the SRI is included in an SRI field of the DCI, and wherein a size of the SRI field is based on a total number of SRI combination for all ranks usable for the non-codebook-based transmission.

10. The apparatus of claim 1, wherein the processing circuitry is further configured to:
indicate, to the base station, for each possible number of demodulation reference signal (DMRS) ports a corresponding SRS resource indicator (SRI) combination.

11. The apparatus of claim 10, wherein the DCI indicates a number of DMRS ports or an SRI, and wherein the processing circuitry is further configured to:
determine the set of the at least eight SRS resources based on the number of DMRS ports or the SRI.

12. The apparatus of claim 1, wherein the processing circuitry is further configured to:
indicate, to the base station, for each possible number of demodulation reference signal (DMRS) ports a corresponding number of SRS resource indicator (SRI) combinations.

13. The apparatus of claim 1, wherein the processing circuitry is further configured to:
determine an SRS resource indicator (SRI) based on the DCI; and
determine the set of the at least eight SRS resources based on the SRI, wherein the SRI is associated with a rank smaller than or equal to “X,” wherein “X” is a positive integer, wherein the DCI has a first DCI format, and wherein the SRI is based on SRS resources configured for a second DCI format.

14. The apparatus of claim 13, wherein “X” is equal to a number of SRS resources in a resource set configured for the second DCI format.

15. The apparatus of claim 1, wherein the processing circuitry is further configured to:
determine an SRS resource indicator (SRI) based on the DCI; and
determine the set of the at least eight SRS resources based on the SRI, wherein the SRI is associated with a rank larger than “X,” wherein “X” is a positive integer, wherein the DCI has a first DCI format, and wherein the SRI indicates SRS resources configured for the first DCI format.

16. A method comprising:
generating, for transmission to a user equipment (UE), configuration information indicating that at least eight sounding reference signal (SRS) resources are configured for a non-codebook-based transmission;
generating, for transmission to the UE, a channel state information reference signal (CSI-RS);
processing an SRS transmission that is received from the UE based on the CSI-RS and that uses the at least eight sounding reference signal (SRS) resources; and
generating, for transmission to the UE, downlink control information (DCI) that indicates a set of the at least eight SRS resources.

17. The method of claim 16, further comprising:
generating, for transmission to the UE, an SRS resource indicator (SRI) combination-DMRS port association based on radio resource control (RCC) signaling or a media access control (MAC) control element (CE), wherein the DCI indicates an SRI for a selection by the UE of an SRI combination.

18. The method of claim 16, wherein the DCI indicates a number of demodulation reference signal (DMRS) ports, and wherein the number of DMRS ports is pre-associated with an SRS resource indicator (SRI).

19. One or more computer-readable storage media storing instructions, that upon execution by one or more processors, cause operations comprising:
processing configuration information received from a base station and indicating that at least eight sounding reference signal (SRS) resources are configured for a non-codebook-based transmission;
processing a channel state information reference signal (CSI-RS) received from the base station;
generating, for transmission to the base station and based on a measurement of the CSI-RS, an SRS using the at least eight SRS resources; and
processing downlink control information (DCI) that is received from the base station indicates a set of the at least eight SRS resources.

20. The one or more computer-readable storage media of claim 19, wherein the operations further comprise:
generating, for transmission to the base station, an indication, for each possible number of demodulation reference signal (DMRS) ports, of a corresponding number of SRS resource indicator (SRI) combinations, wherein the indication is sent based on based on UE capability information, uplink control information, or a media access control (MAC) control element (CE).
